(19) United States
(12) Patent Application Publication
(10) Pub. No.: US 2026/0028866 A1
(43) Pub. Date: Jan. 29, 2026

(54) GUIDE SYSTEM FOR MOVABLY SUPPORTING A COVER ELEMENT

(71) Applicant: Julius Blum GmbH, Hoechst (AT)

(72) Inventors: Florian FISCHER, Hoechst (AT); Gerhard KLEINSASSER, Dornbirn (AT); Hermann HAEMMERLE, Lustenau (AT); Matthias REISSIG, Lindau (DE); Alexander Simon FLOGAUS, Eriskirch (DE)

(21) Appl. No.: 19/350,633

(22) Filed: Oct. 6, 2025

Related U.S. Application Data
(63) Continuation of application No. PCT/AT2024/060134, filed on Apr. 10, 2024.

(30) Foreign Application Priority Data
Apr. 12, 2023 (AT) A 50261/2023

(51) Int. Cl. E05F 15/60; E05D 15/56

(52) U.S. Cl. CPC E05F 15/60; E05D 15/56; E05Y 2201/218; E05Y 2201/626; E05Y 2900/10

(57) ABSTRACT

A guide system for movably supporting a cover element for covering an opening in a stationary structure, the a cover element being movable by the guide system between a closed position, in which the a cover element covers the opening, and an open position, in which the cover element is spaced apart from the opening substantially orthogonally. The guide system includes a hinge including a first fitting portion to be arranged on the stationary structure, a second fitting portion configured to be arranged on the cover element, and a hinge lever mechanism configured to move the two fitting portions substantially linearly between a first end position, corresponding to a closed position of the cover element, and a second end position, corresponding to an open position of the cover element. A locking device is configured to lock the fitting portions in the first end position and/or in the second end position.

### BACKGROUND OF THE INVENTION

The present invention relates to a guide system for movably supporting at least one cover element for covering an opening in a stationary structure, the at least one cover element being movable by the guide system between a closed position, in which the at least one cover element covers the opening, and an open position, in which the at least one cover element is spaced apart from the opening substantially orthogonally.

Further, the invention relates to an arrangement comprising a stationary structure, at least one opening formed therein, at least one cover element and at least one guide system of the type to be described.

EP 0 763 643 A1 discloses a fitting for movably supporting a wing of a window or a door. The fitting is configured to move the wing in a first step from a closed position, in which the door wing covers an opening of a building, into a tilted position, in which the wing is inclined relative to the plane of the opening of the building. In a second step, the wing is movable into a position in which the wing is spaced apart from the opening of the building in a parallel relationship, thereby projecting into the interior of a living space. In a third step, the wing is displaceable from the parallel-spaced position in a horizontal direction so as to reveal the opening of the building. A drawback is the fact that the wing has to be moved from the closed position into a tilted position and, subsequently, into a parallel position relative to the opening of the building, before the wing can be displaced in a horizontal direction. A further drawback is the fact that the wing, in the tilted position, in the parallel position and the laterally displaced position, always projects into the interior space. This is, in particular with confined space conditions, disturbing and the arrangement of objects in the region of the window is hindered or even impossible.

### SUMMARY OF THE INVENTION

It is an object of the present invention to propose a hinge of the type mentioned in the introductory part, thereby avoiding at least one of the above-mentioned drawbacks.

According to the invention, the guide system:
includes at least one, preferably more than one, hinge, the at least one hinge including at least a first fitting portion configured to be arranged on the stationary structure, at least a second fitting portion configured to be arranged on the at least one cover element, and at least one hinge lever mechanism configured to move the two fitting portions substantially linearly between a first end position, which corresponds to a closed position of the cover element, and a second end position, which corresponds to an open position of the cover element, and
at least one locking device configured to lock the two fitting portions in the first end position and/or in the second end position.

In other words, the at least one hinge of the guide system includes a hinge lever mechanism for the hinged connection between the two fitting portions, the two fitting portions of the hinge being linearly displaceable relative to each other. In this way, a movement of the cover element in parallel planes can be made possible, that is to say that the cover element is movable parallel to itself.

In this way, a simple and intuitive opening movement of the cover element with a precise linear guide can be made possible, without the need that the cover element has to be moved or tilted transversely to a plane of a stationary frame.

The at least one locking device allows the two fitting portions to be releasably locked in the first end position and/or in the second end position. In this way, a defined closed position of the cover element and an effective burglary protection can be provided.

After the movement of the cover element between the first, closed end position and the second, open end position, at least one fitting portion of the hinge is movable along a guide into a lateral displacement position, preferably via at least one running carriage comprising at least one running wheel. In the lateral displacement position, the opening of the stationary structure can be substantially revealed by the cover element.

The purpose of locking the second end position of the fitting portions is to block a relative movement of the hinge lever mechanism in order to prevent the hinges from buckling when the cover element is laterally displaced.

### BRIEF DESCRIPTION OF THE DRAWINGS

Further details and advantages of the present invention will be apparent from the following description with reference to the drawings, in which:

FIG. 1a-1c show a stationary structure with a cover element in different positions for covering an opening arranged in the stationary structure,

FIG. 2a, 2b show the stationary structure and the cover element in perspective views,

FIG. 3a-3c are cross-sectional views of the cover element in the closed position and in an open position, and an enlarged detail view thereof,

FIG. 4a, 4b show a guide system with a plurality of hinges for movably supporting the cover element and an enlarged detail view thereof,

FIG. 5a, 5b show the guide system according to FIGS. 4a, 4b in further relative positions of the hinges to each other, and an enlarged detail view thereof,

FIG. 6a, 6b show the guide system according to FIGS. 4a, 4b, 5a, 5b in further relative positions of the hinges to each other, and an enlarged detail view thereof,

FIG. 7a-7c are perspective views of a hinge in different positions of the two fitting portions relative to each other,

FIG. 8 shows the hinge in an exploded view,

FIG. 9a, 9b show a part of the guide system in two different perspective views,

FIG. 10a, 10b show the cover element in an open position and in a closed position relative to the stationary structure,

FIG. 11a-11d show the cover element in different embodiments,

FIG. 12a, 12b show two different embodiments of a cover element with a multiple-pane insulation glass,

FIG. 13 is an exploded view of a part of the guide system with a locking device for releasably locking the two fitting portions in the first end position and/or in the second end position,

FIG. 14a-14d show the unlocking operation of the first end position of the two fitting portions in temporally subsequent steps,

FIG. 15a-15c show the driving operation of the fitting portions in a direction of the second end position in temporally subsequent steps,

FIG. 16a-16c show the arrangement of an inclinedly extending hinge axis on the first fitting portion in different views, and

FIG. 17a-17c show a movement of the fitting portions from the first end position in a direction of the second end position.

### DETAILED DESCRIPTION OF THE INVENTION

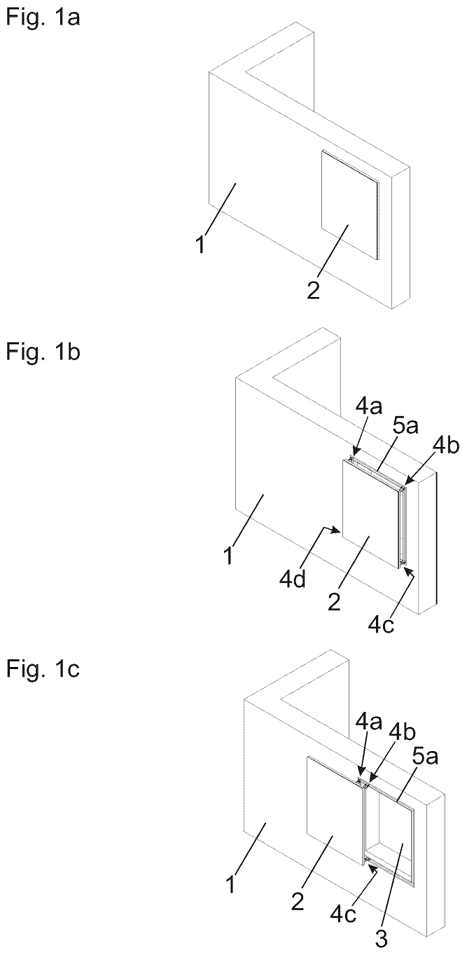

FIG. 1a shows a stationary structure 1 with an opening 3 (FIG. 1c), the opening 3 being configured to be covered by at least one cover element 2. The cover element 2 can have a one-part configuration or also a multi-part configuration. With a multi-part configuration of the cover element 2, the individual components of the cover element 2 can be movably, preferably pivotally, connected to each other.

The cover element 2 can be a window, a blind and/or a door. In a closed condition, the cover element 2 and be arranged flush with the stationary structure 1 or can be arranged so as to slightly project from the opening 3 of the stationary structure 1.

For example, the stationary structure 1 can be an inner or outer building wall for example.

The opening 3 of the stationary structure 1 can be a window opening or a door opening for example.

In a closed position, the cover element 2 substantially entirely covers the opening 3. A plane formed by an outer side of the cover element 2 and an outer side of the stationary structure 1 are arranged substantially coplanar (thus substantially flush with a facade) relative to each other. However, the cover element 2 may slightly project over the outer side of the stationary structure 1.

The cover element 2 is movable from the closed position according to FIG. 1a to the outside in a linear direction into an open position, in which the cover element 2 is spaced apart from the opening 3 in a substantially parallel relationship.

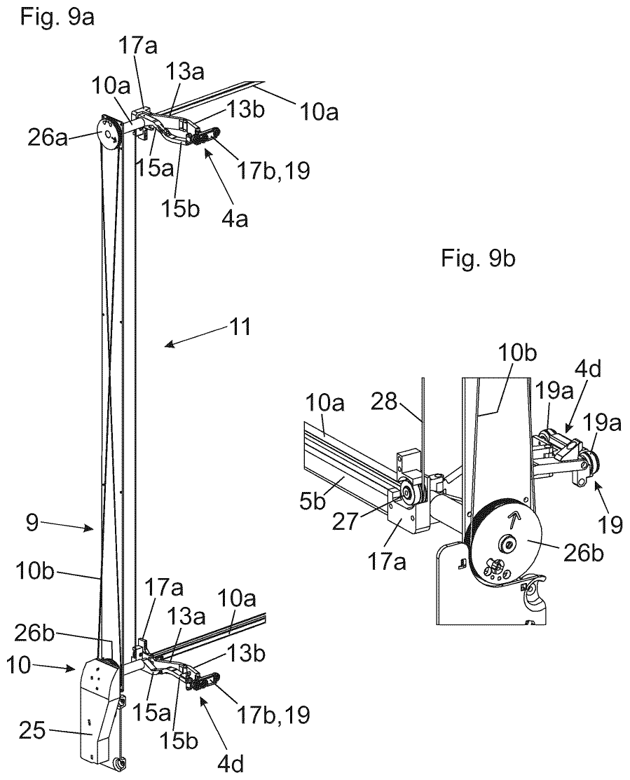

In a first movement section, the cover element 2 is thus movable relative to the stationary structure 1 in a parallel manner, so as to ventilate a room of a building for example. This can be accomplished either manually or by at least one, preferably automated and/or electromotive, drive device 25 (FIG. 9a).

According to an embodiment, the at least one drive device 25 is coupled or is configured to be coupled to a control or regulation device, preferably a building control system. Here, at least one sensor, preferably a CO2 sensor, can be provided so as to measure a property of a building. The at least one drive device 25 is configured to be activated by the control or regulation device, preferably in dependence on a sensor signal of the at least one sensor.

For example, the building control system is configured to initiate the at least one drive device 25 in dependence on light conditions, a time rule, a temperature, an air moisture and/or an air quality in order to move the cover element 2 in a partial or into a fully open position so as to ventilate the room.

In a second movement section of the cover element 2, a movement outside the room along the stationary structure 1 and in a direction extending perpendicular to the direction of the previous first movement section is possible.

FIG. 1b shows the cover element 2 in a position in which the cover element 2 is orthogonally spaced apart from the opening 3.

In the shown embodiment, four hinges 4a, 4b, 4c, 4d are provided for moving the cover element 2 substantially linearly between a first end position corresponding to a closed position of the cover element 2, and a second end position corresponding to an open position of the cover element 2.

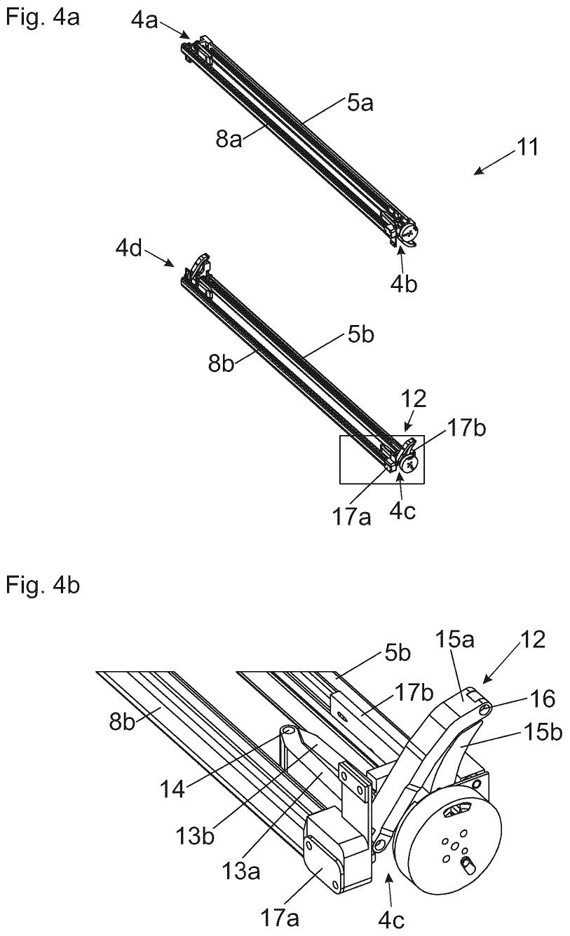

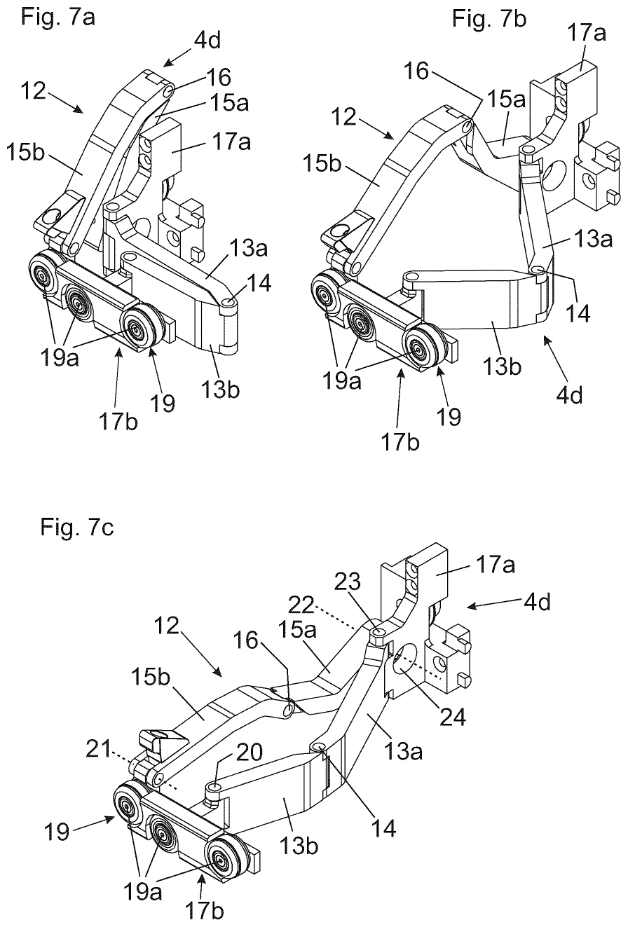

The two hinges 4a, 4d arranged above each other are fixed to the stationary structure 1, and a running carriage 19 (FIG. 7a-7c) of the hinges 4a, 4d is displaceable along at least one guide 8a, 8b (FIG. 4a) fixed to the cover element 2.

On the contrary, the two other hinges 4b, 4c arranged above each other are fixed to the cover element 2, and a running carriage 19 (FIG. 7a-7c) of the hinges 4b, 4c is displaceable along at least one guide 5a, 5b (FIG. 4a) to be fixed to the stationary structure 1.

In the shown embodiment, two guides 8a, 8b (FIG. 4a) are fixed to the cover element 2 so as to be mutually spaced apart from each other in a height direction, and two guides 5a, 5b (FIG. 4a) are fixed to the stationary structure 1 so as to be mutually spaced apart from each other in a height direction.

According to an embodiment, the, preferably substantially quadrangular, cover element 2 is configured to be positioned outwardly from the closed position according to FIG. 1a at the four corners substantially perpendicularly to the outside, for example by approximately 125 mm (FIG. 1b).

The guide system 11 can include four hinges 4a-4d which are arranged, in the closed position, in a region of the four edges of the cover element 2. Preferably, two hinges 4a, 4d are vertically spaced apart from each other on the stationary structure 1, and two hinges 4b, 4c are vertically spaced apart from each other on the cover element 2 and are connected to the cover element 2 in a movement-coupled manner.

This can be accomplished by a common, preferably electromotive, drive device 25 (FIG. 9a).

From the position shown in FIG. 1b, the cover element 2 is movable into a displacement position, in which the cover element 2 is arranged laterally offset with respect to the opening 3.

FIG. 1c shows the cover element 2 in a displacement position, in which the cover element 2 is arranged laterally offset with respect to the opening 3. The hinges 4a, 4d are fixed to the stationary structure 1, whereas the running carriages 19 of the two other hinges 4b, 4c are displaceable along the guides 5a, 5b.

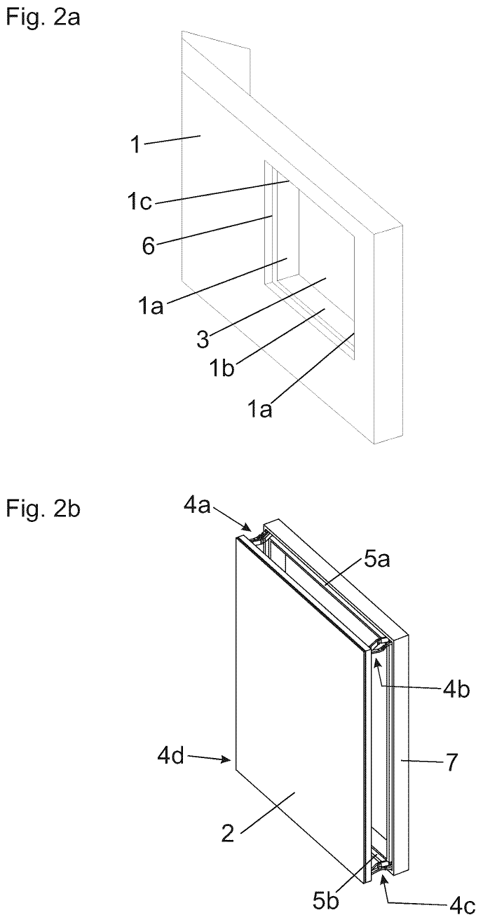

FIG. 2a shows the stationary structure 1 in a perspective view. The stationary structure 1 includes at least one rabbet 6 surrounding the at least one opening 3, two opposing soffits 1a, a windowsill 1b and a lintel 1c.

FIG. 2b shows the cover element 2 in a perspective view. The cover element 2 is linearly displaceably supported via the hinges 4a, 4b, 4c, 4d relative to a frame 7 to be fixed to the stationary structure 1, so as to always guide the cover element 2 between the first end position (closed position) and the second end position (open position) parallel to the frame 7.

On each of the four corners, a hinge 4a, 4b, 4c, 4d with two knee-lever pairs is arranged. Two hinges 4a, 4d are arranged on the stationary structure 1 on the building-site, and two hinges 4b, 4c are arranged on the cover element 2.

The movement of the hinges 4a, 4b, 4c, 4d is horizontally synchronized on the one hand, and vertically synchronized on the other hand. With the hinges 4a, 4b, 4c, 4d, one knee-lever pair takes over a supporting function, and one knee-lever pair takes over the movement-leading function.

By at least one knee-lever of the hinges 4a, 4b, 4c, 4d, in a first movement path from the first end position (closed position), a high force transmission with a low path-transmission ratio can be brought about. Subsequently, in a second movement path, a large path-transmission ratio with a reduced force transmission until reaching the second end position (open position) can be provided.

By at least one knee-lever, a very compact design of the hinges 4a, 4b, 4c, 4d can be made possible.

Another advantage of using at least one knee-lever lies in the fact that a rotational movement of a, preferably electromotive, drive device 25 can be very easily converted into a linear movement of the cover element 2.

In a mounted condition of the cover element 2, the frame 7 is arranged substantially flush with the soffit 1a and/or flush with the windowsill 1b and/or flush with the lintel 1c. Therefore, no disturbing abutting edge is formed between the frame 7 and the soffit 1a, the windowsill 1b and/or the lintel 1c.

Due to the faces between the frame 7, the soffit 1a, the windowsill 1b and the lintel 1c extending flush with each other, a person located with the interior space gains the impression that a glass surface formed by the cover element 2 extends to the soffit 1a, to the windowsill 1b and to the lintel 1c without the formation of a step.

Each of the guides 5a, 5b is integrated into the frame 7 and the other guides 8a, 8b are integrated into the cover element 2. In a closed condition of the cover element 2, the guides 5a, 5b of the frame 7 and the guides 8a, 8b arranged in the cover element 2 are not visible.

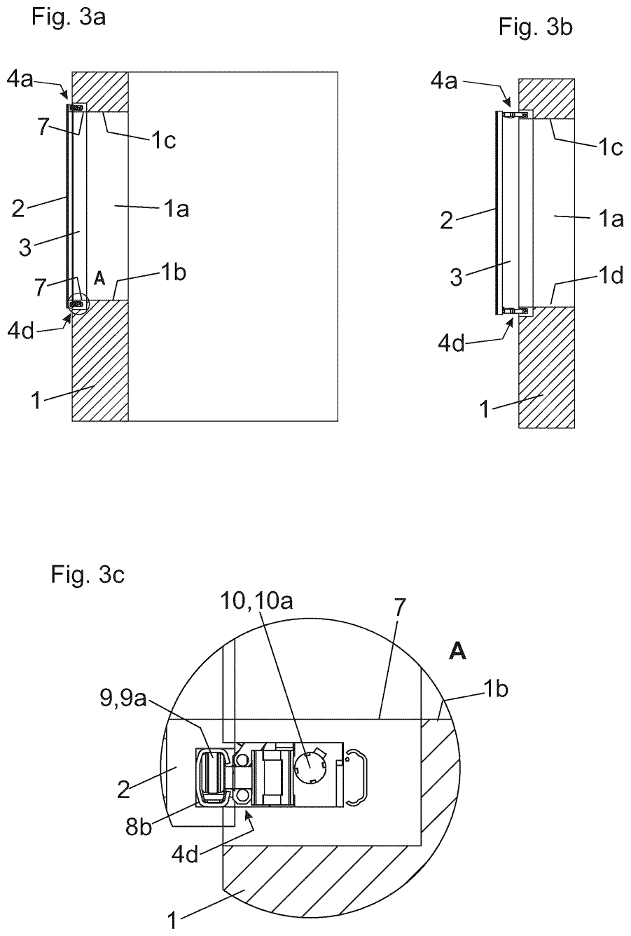

FIG. 3a shows a cross-sectional view of the cover element 2 in a closed position relative to the stationary structure 1.

It can be recognized that the frame 7 of the cover element 2 as well as the soffits 1a, the windowsill 1b and the lintel 1c of the stationary structure 1 extend flush with each other. In this way, a surface formed by the opening 3 of the stationary structure 1 can be substantially entirely covered by a surface of the cover element 2, preferably made of glass.

FIG. 3b shows the cover element 2 in an open position, in which the cover element 2 is spaced apart from the opening 3 substantially orthogonally. The cover element 2 is linearly movable by the hinges 4a, 4b, 4c, 4d between the closed position and the shown open position.

FIG. 3c shows the encircled region “A” of FIG. 3a in an enlarged view. The guide 8b can be recognized, the guide 8b being substantially entirely integrated into the cover element 2. The frame 7 of the cover element 2 and the windowsill 1b extend substantially coplanar relative to each other.

The hinge 4d is fixed to the stationary structure 1 on the one hand, and the guide 8b fixed to the cover element 2 is displaceable between the open position and the displacement position along the running carriage 9 comprising at least one running wheel 9a.

A synchronization device 10 can be recognized, and a movement of at least two hinges 4a-4d can be synchronized with each other by the synchronization device 10.

In the shown embodiment, the synchronization device 10 includes at least one synchronization shaft 10a and/or at least one cable pulley 9 (FIG. 9) configured to synchronize a movement of at least two hinges 4a-4d with each other.

FIG. 4a shows a guide system 11 comprising a plurality, preferably precisely four, hinges 4a, 4b, 4c, 4d for movably supporting the cover element 2.

The guide system 11 includes an upper guide 5a to be fixed to or within the stationary structure 1. A further guide 8a is to be fixed to or within the cover element 2. By the hinges 4a, 4b, a distance of the two guides 5a, 8a (and therewith a position of the cover element 2) is variable in a linearly extending direction.

The guide system 11 further includes a lower guide 5b to be fixed to or within the stationary structure 1. A further guide 8b is to be fixed to or within the cover element 2. By the lower hinges 4c, 4d, a distance of the two guides 5b, 8b (and therewith a position of the cover element 2) is variable in a linearly extending direction.

The recessed guides 5a, 5b, 8a, 8b allow the cover element 2 to be arranged flush with the adjacent areas, and there is no guide 5a, 5b, 8a, 8b visible in a closed condition.

The guides 5a, 5b, 8a, 8b are preferably configured as guide rails.

FIG. 4b shows the framed region of FIG. 4a in an enlarged view. On this position, the hinge 4c can be recognized, and the structure of the hinges 4a, 4b, 4c, 4d can be basically identical.

The hinge 4c includes a first fitting portion 17a to be arranged on the cover element 2, preferably to be arranged on the guide 8b of the cover element 2.

A second fitting portion 17b is configured to be displaceably supported on the stationary structure 1, preferably configured to be displaceably supported along the guide 5b to be fixed to the stationary structure 1.

The two fitting portions 17a, 17b are connected to each other via a hinge lever mechanism 12 such that the two fitting portions 17a, 17b are movable substantially linearly between a first end position corresponding to the closed position of the cover element 2, and a second end position corresponding to an open position of the cover element 2.

In the second end position, the two fitting portions 17a, 17b are further spaced apart from each other than in the first end position. For example, the two fitting portions 17a, 17b can have a distance between 50 mm and 200 mm, preferably a distance between 100 mm and 150 mm, relative to each other in the second end position.

In the shown embodiment, the hinge lever mechanism 12 includes at least two supporting levers 13a, 13b hingedly connected to each other via a first hinge axis 14, and at least two drive levers 15a, 15b hingedly connected to each other via a second hinge axis 16.

According to a preferred embodiment, the two hinge axes 14, 16 extend substantially orthogonally to each other.

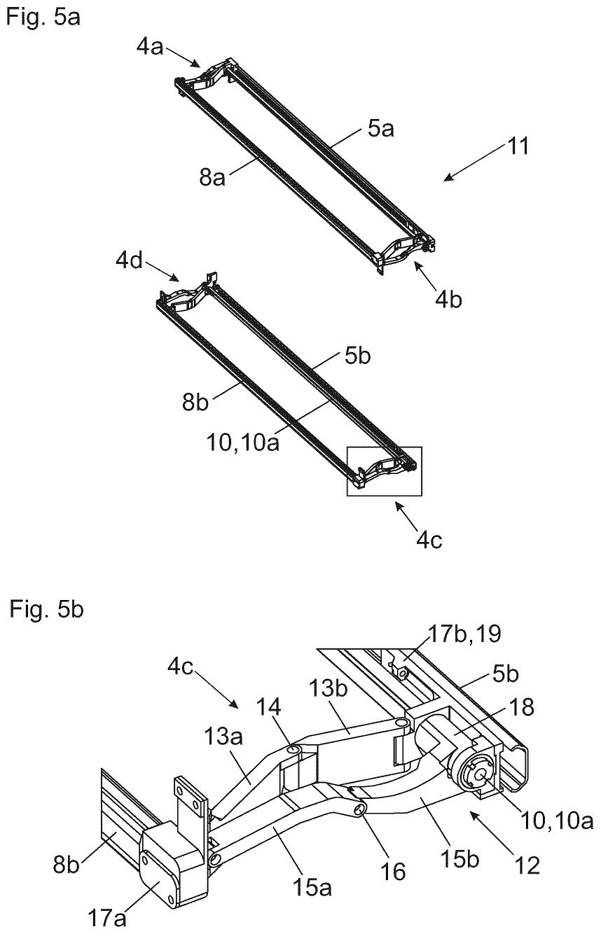

FIG. 5a shows the guide system 11 according to FIGS. 4a, 4b in further relative positions of the hinges 4a, 4b, 4c, 4d to each other. The two hinges 4a, 4d arranged above each other are stationary relative to the stationary structure 1, and the guide 8a to be fixed to the cover element 2 is movable relative to a running carriage 19 of the stationary hinges 4a, 4d.

The two other hinges 4b, 4c, on the other hand, are to be fixed to the cover element 2 and, when the cover element 2 moves between the open position, in which the cover element 2 is spaced apart from the opening 3 substantially orthogonally, and the displacement position, in which the cover element 2 is arranged laterally offset relative to the opening 3, along the guides 5a, 5b to be fixed to the stationary structure 1.

FIG. 5b shows the framed region of FIG. 5a in an enlarged view. The hinge lever mechanism 12 includes two supporting levers 13a, 13b hingedly connected to each other via a first hinge axis 14, the supporting levers 13a, 13b bearing a load of the cover element 2.

The two drive levers 15a, 15b of the hinge lever mechanism 12 are connected to each other via a second hinge axis 16, the drive levers 15a, 15b being configured to vary the relative distance of the two fitting portions 17a, 17b to each other.

The two hinge axes 14, 16 can extend substantially orthogonally relative to each other.

The drive lever 15b is connected to the synchronization shaft 10a of the synchronization device 10 via a form-locking connection 18. In this way, a rotational movement of a drive lever 15a, 15b of a first hinge 4a-4d can be synchronized with a rotational movement of a drive lever 15a, 15b of a second hinge 4a-4d.

Preferably, at least one hinge 4a-4d is displaceably supported, at least over a region, along the at least one synchronization shaft 10a of the synchronization device 10. In this way, a compact construction with a precise linear guidance of the hinge 4a-4d along the synchronization shaft 10a can be made possible.

In the shown embodiment, at least one hinge 4a-4d is displaceably supported along the synchronization shaft 10a of the synchronization device 10 via at least one form-locking connection 18.

The hinges 4b, 4c are thus movably supported along the guides 5a, 5b to be fixed to the stationary structure 1 and/or along at least one synchronization shaft 10a of the synchronization device 10.

Upon a movement of the hinge 4a-4d from the first end position into the second end position, a distance of the at least one second fitting portion 17b relative to the at least one first fitting portion 17a can be enlarged such that an inner side of the at least one cover element 2 to be connected to the second fitting portion 17b is further spaced apart from the at least one first fitting portion 17a in the second end position than in the first end position. In other words, the cover element 2 can be opened to the outside relative to the stationary structure 1.

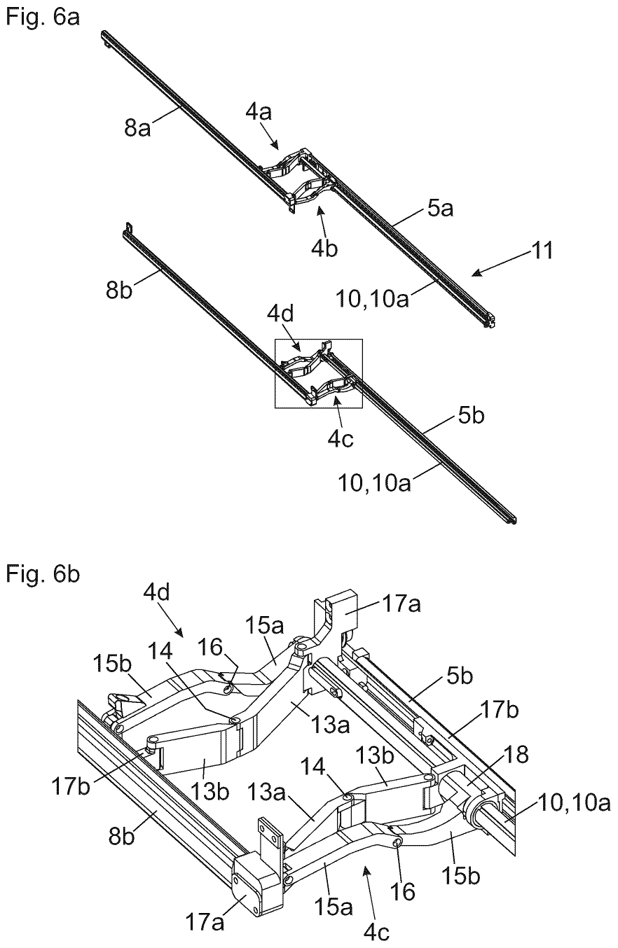

FIG. 6a shows the guide system 11 in the displacement position of the cover element 2, in which the cover element 2 is arranged laterally offset with respect to the opening 3 of the stationary structure 1. The position of the cover element 2 thus corresponds to the position of the cover element 2 according to FIG. 1c.

It can be recognized that the two hinges 4b, 4c arranged on the cover element 2, upon a movement of the cover element 2 between the open position, in which the cover element 2 is spaced apart from the opening 3 substantially orthogonally, and the displacement position, in which the cover element 2 is arranged laterally offset with respect to the opening 3, are movable along the two guides 5a, 5b which are spaced apart from each other in a height direction and/or along the two synchronization shafts 10a of the synchronization device 10 spaced apart from each other in the height direction.

FIG. 6b shows the framed region of FIG. 6a in an enlarged view.

Each of the hinges 4b, 4c is arranged on the guides 8a, 8b to be fixed to the cover element 2, and each of the second fitting portions 17b of the hinges 4b, 4c is movable along the guides 5a, 5b to be fixed to the stationary structure 1.

The two other hinges 4a, 4d, in contrast, are arranged on the guides 5a, 5b to be fixed to the stationary structure 1, and each of the two second fitting portions 17b of the hinges 4a, 4d is movable along the guides 8a, 8b to be fixed to the cover element 2.

FIG. 7a-7c show the hinge 4d in different relative positions of the fitting portions 17a, 17b to each other.

FIG. 7a shows the closed position of the hinge 4d, in which the two fitting portions 17a, 17b adopt a smallest distance relative to each other.

FIG. 7b shows an intermediate position of the hinge 4d, the intermediate position corresponding approximately to a half-opened position of the cover element 2 between the first end position (closed position) and the second end position (open position).

FIG. 7c shows the second end position (open position) of the hinge 4a-4d. In the second end position, a tilting movement of one of the knee-lever pairs is blocked so as to block a tilting movement of the hinge 4d upon a lateral displacement of the cover element 2.

In order to move the cover element 2 from the second end position into the lateral displacement position, at least one unlocking element (not shown), for example a clamping lever, has to be actuated. This serves, in particular, for the safety of children. In other words, it shall be prevented that a child displaces the cover element 2 in a lateral direction, thereby falling out from the opening 3 of the stationary structure 1.

The at least one unlocking element can also be coupled to a brake configured to automatically clamp the cover element 2 on the guides 5a, 8a; 5b, 8b in each position when the unlocking element is released.

In other words, the unlocking element must be actuated in order to laterally displace the cover element 2. This function shall also prevent the cover element 2 from being moved sideways by strong winds.

A handle of the unlocking element can be recessed into the window frame, making the handle invisible when the cover element 2 is closed and flush with the facade.

By folding out the handle, an automatic unlocking and/or a release of the brake for unblocking a movement of the cover element 2 between the second end position and the lateral displacement position can be provided. The handle can be configured to be set into different positions or, in the case of the brake, is continuously adjustable.

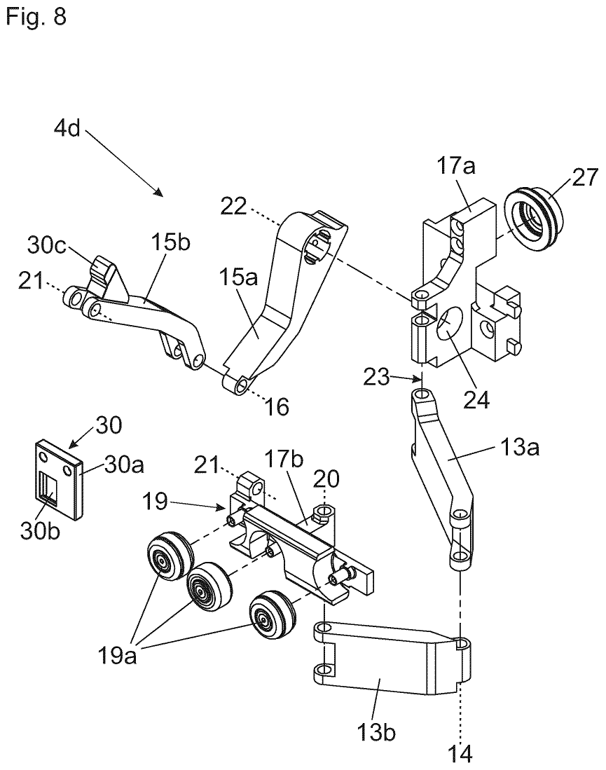

FIG. 8 shows the hinge 4d in an exploded view.

According to possible embodiments, the hinge lever mechanism 12
includes more than four, preferably precisely six, hinge axes 14, 16, 20, 21, 22, 23, and/or
includes at least one, preferably more than one, supporting lever 13a, 13b and/or at least one, preferably more than one, drive lever 15a, 15b configured to be curved or angled at least over a region.

At least one fitting portion 17a, 17b can include at least one, preferably circular, recess 24 for the passage of a synchronization shaft 10a and/or for the displaceable support of a fitting portion 17a, 17b along the synchronization shaft 10a of the synchronization device 10.

By at least one deflection roller 27 and at least one cable pulley 28 (FIG. 9b), a tilting moment of the cover element 2 upon a movement between the second end position (open position) and the lateral displacement position can be compensated for. This function will be described in greater detail in connection with FIGS. 9a, 9b.

FIG. 9a shows a part of the guide system 11 in a perspective view, in which the upper hinge 4a and the lower hinge 4d can be recognized. The hinges 4a, 4d, in a mounted position, are arranged stationarily relative to the stationary structure 1.

A movement of the lower hinge 4d can be synchronized with the other lower hinge 4c (not shown here) via the lower synchronization shaft 10a.

By an upper, second synchronization shaft 10a, a movement of the two other upper hinges 4a, 4b can be synchronized with each other.

The fitting portions 17a of the hinges 4a, 4d are connected to their associated synchronization shafts 10a of the synchronization device 10 in a form-locking manner. As a result, upon a rotational movement of the synchronization shaft 10a, the fitting portions 17a of the hinges 4a, 4d are also moved therewith.

Preferably, at least one hinge 4a-4d is configured to be driven by a, preferably electromotive, drive device 25 between the first end position (closed position) and the second end position (open position).

For example, the, preferably electromotive, drive device 25 is configured to be controlled via at least one radio switch.

As an alternative or in addition to an electromotive drive device 25, at least one manual drive device 25 can be provided, for example a crank handle. For example, a crank handle can be useful in the event of a power failure of an electromotive drive device 25.

In the shown embodiment, the lower synchronization shaft 10a of the synchronization device 10 is configured to be driven by at least one, preferably electromotive, drive device 25.

The synchronization device 10 further includes at least one cable pulley 9 for vertical synchronization, that is to say for synchronizing a movement of at least two hinges 4a, 4d arranged above each other.

In the shown embodiment, the cable pulley 9 includes at least two drive wheels 26a, 26b and at least one cable 10b arranged between the two drive wheels 26a, 26b, the cable 10b preferably extending in the shape of an eight.

The vertical synchronization of the hinges 4a, 4d thus includes a cable 10b in the shape of an eight which allows a synchronous rotation of the two horizontal synchronization shafts 10a in opposite directions.

By the, preferably electromotive, drive device 25, the lower drive wheel 26b can be driven, and a rotational movement of the lower drive wheel 26b can be transmitted to the upper hinge 4a via the cable 10b of the synchronization device 10 and via the at least one further drive wheel 26a.

Preferably, a rotational movement of the upper drive wheel 26a can be transmitted via an upper synchronization shaft 10a to the upper hinge 4a and/or to the other upper hinge 4b (not shown here).

The drive device 25 can be arranged at various locations. For example, the drive device can be arranged at one of the corners or in the middle on a vertical side of the frame 7 (FIG. 2b).

Likewise, at least two, preferably electromotive, drive devices 25 can be provided, the drive devices 25 being arranged diagonally at the corners of the frame 7. In such a case, the arrangement of an upper synchronization shaft 10a can be omitted.

The two horizontal synchronization shafts 10a, during the outward movement of the cover element 2 between the closed position and the open position, are pivoted about approximately 120°.

The closing movement of the cover element 2 from the lateral displacement position via the second end position (open position) into the first end position (closed position) takes place in a reversed manner.

In order to detect the reaching of the second end position (open position) of at least one hinge 4a-4d, at least one sensor (for example a metal detector) or a switch can be provided, thereby activating the power supply to the drive device 25 or interrupting the power supply to the drive device 25 upon the opening movement of the cover element 2 between the first end position (closed position) and the second end position (open position). In this way, it can be ensured that the drive device 25 is only activated when the second end position has been reached. For example, the switch can be actuated by a moving running carriage 19 of one of the window-sided hinges 4b, 4c.

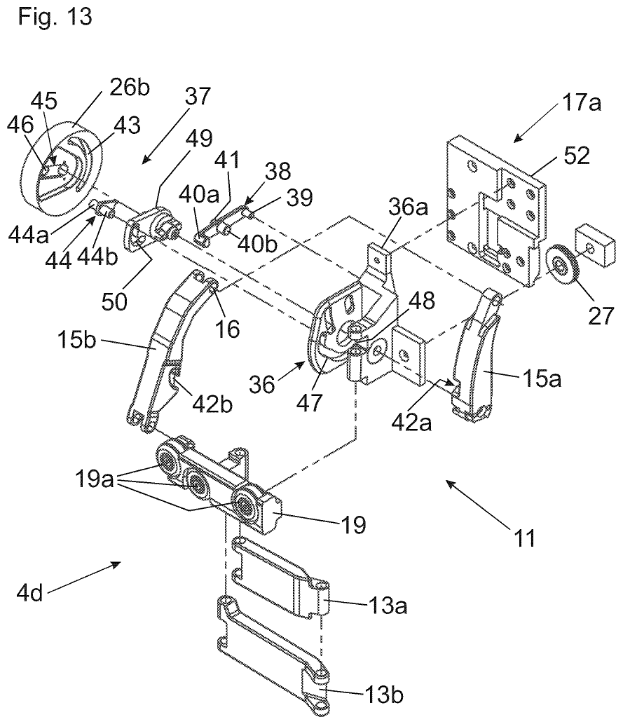

The cover element 2 is releasably lockable in the first end position (closed position) in order to reach a defined end position and to prevent break-ins. This can be accomplished by at least one locking device 37 (FIG. 13), for example comprising at least one lockable pin 40a, 40b.

FIG. 9b shows the lower region of the guide system 11 according to FIG. 9a in a different perspective view.

The drive wheel 26b configured to be driven by the drive device 25 can be recognized, and the cable 10b of the synchronization device 10 is guided around the drive wheel 26b, preferably multiple times.

Upon a displacement of the cover element 2 from the open position into the lateral displacement position, the cover element 2 has the increasing tendency to tilt to the left and down in the plane of the cover element 2 due to the force of gravity (FIG. 1c).

In order for this tilting moment to be compensated for, at least one cable pulley 28 is provided. A length of the cable pulley 28 is shortened by a shortening device upon a displacement of the cover element 2 from the second end position (open position) of the fitting portions 17a, 17b into the lateral displacement position of the cover element 2.

For example, the shortening device can include a conical drum, and the cable pulley 28 can be winded up and/or unwinded upon a continued opening movement of the cover element 2 in a non-linear manner.

As an alternative or in addition to a conical drum, a length of the cable pulley 28 can be shortened by varying a position of at least one deflection roller 27.

In other words, the cable pulley 28 which is required for the load transfer during the lateral displacement movement is dimensioned such that the moment increasing upon a continuation of the opening movement is compensated for, preferably by the conical drum and/or by changing the position of at least one deflection roller 27. As a result, a sagging movement of the cover element 2 can be prevented. It would also be possible for the cover element 2 to be slightly elevated by the cable pulley 28 upon a movement of the cover element 2 between the open position and the displacement position.

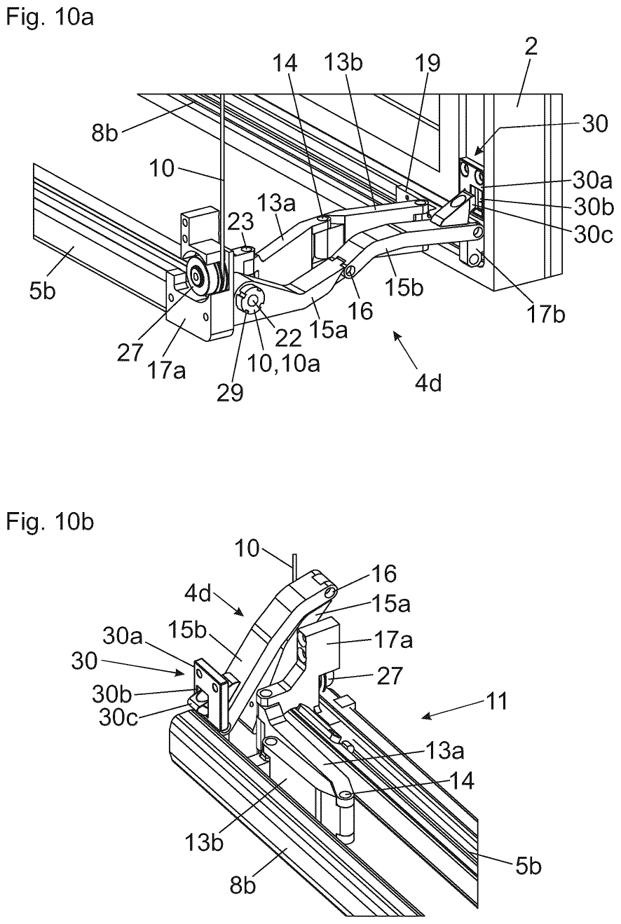

FIG. 10a shows the cover element 2 in the second end position (open position) relative to the stationary structure 1. The guide 5b is fixed to or in the stationary structure 1 and the hinges 4a, 4d are stationarily arranged relative to the guide 5b.

The synchronization shaft 10a of the synchronizing device 10 can be recognized. The synchronization shaft 10a can include a plurality of grooves 29 extending in the longitudinal direction of the synchronization shaft 10a, the grooves 29 serving for fixing at least one hinge 4a-4d in a form-locking manner and/or for the displaceable support of at least one hinge 4a-4d.

In the shown embodiment, the synchronization shaft 10a is rotationally supported about a rotational axis, and the rotational axis of the synchronization shaft 10a extends coaxially to a hinge axis 22 of the hinge 4d.

The other fitting portion 17b is displaceable along a guide 8b fixed to or in the cover element 2 via a running carriage 19 having at least one running wheel 19a.

By a centering device 30, at least one drive lever 15a, 15b can be centered relative to the cover element 2 and prevents excessive relative movement between the cover element 2 and the drive levers 15a, 15b, when the cover element 2 is located in the closed position (FIG. 10b).

The centering device 30 includes at least one mounting portion 30a to be fixed to the cover element 2, the mounting portion 30a including an opening 30b. At least one protrusion 30c arranged on the drive lever 15b engages into the opening 30b of the mounting portion 30a in a closed position of the cover element 2.

FIG. 10b shows the guide system 11 in a position corresponding to the closed position of the cover element 2 relative to the stationary structure 1. For the sake of improved overview, the cover element 2 is not depicted. It can be recognized that the at least one protrusion 30c of the drive lever 15b engages into the opening 30b of the mounting portion 30a of the centering device 30.

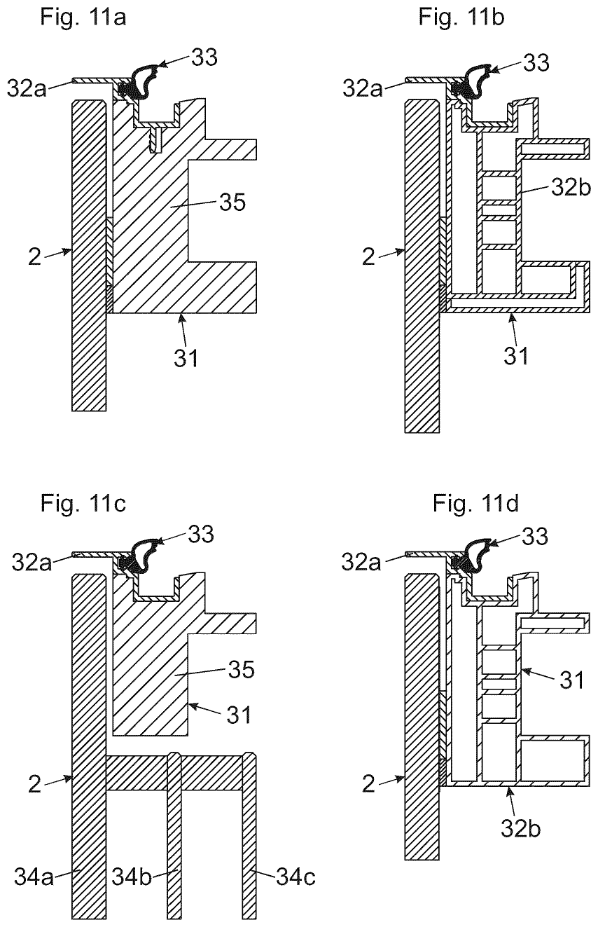

FIG. 11a-11d show the cover element 2 in different embodiments. Of course, other designs or material combinations are also possible to reduce thermal conductivity and/or thermal bridges.

FIG. 11a shows a first embodiment, in which the cover element 2 is a vacuum insulation glass and is movable relative to the stationary structure 1 via a cover frame 31. Here, the cover frame 31 includes a profile 35, preferably made of wood, and at least one further profile 32a. The profile 32a can consist of metal, preferably aluminum, or of a plastic material.

By at least one, preferably strip-shaped, sealing element 33, the cover frame 31 can be sealed relative to the stationary structure 1 when the cover element 2 is located in the closed position, in particular sealed to the frame 7 (FIG. 2b) of the cover element 2.

FIG. 11b shows a second embodiment, in which the cover element 2 is a vacuum insulation glass and is movable relative to the stationary structure 1 via a cover frame 31.

Here, the cover frame 31 includes at least two profiles 32a, 32b, preferably made of metal, in particular aluminum, connected to each other. By at least one, preferably strip-shaped, sealing element 33, the cover frame 31 can be sealed relative to the stationary structure 1 when the cover element 2 is located in the closed position.

FIG. 11c shows a third embodiment, in which the cover element 2 is formed as a stepped rabbet glass having two or more glass panels 34a, 34b, 34c, preferably with different thicknesses. The glass panels 34a, 34b, 34c are at least partially spaced apart from each other. Cavities are arranged between the glass panels 34a, 34b, 34c, the cavities being closed in a gas-tight and in a moisture-tight manner and serving for acoustic and thermal insulation.

The cover frame 31 includes at least one first profile 35, preferably made of wood, and at least one second profile 32a connected to the first profile 35. For example, the second profile 32a can made of metal or plastic. By at least one, preferably strip-shaped, sealing element 33, the cover frame 31 can be sealed relative to the stationary structure 1 when the cover element 2 is located in the closed position.

FIG. 11d shows a fourth embodiment, in which the cover element 2 is a vacuum insulation glass and the cover frame 31 includes at least two profiles 32a, 32b made of different materials. In the shown embodiment, the profile 32a is made of plastic and/or the other profile 32b is made of metal, in particular aluminum. By at least one, preferably strip-shaped, sealing element 33, the cover frame 31 can be sealed relative to the stationary structure 1 when the cover element 2 is located in the closed position.

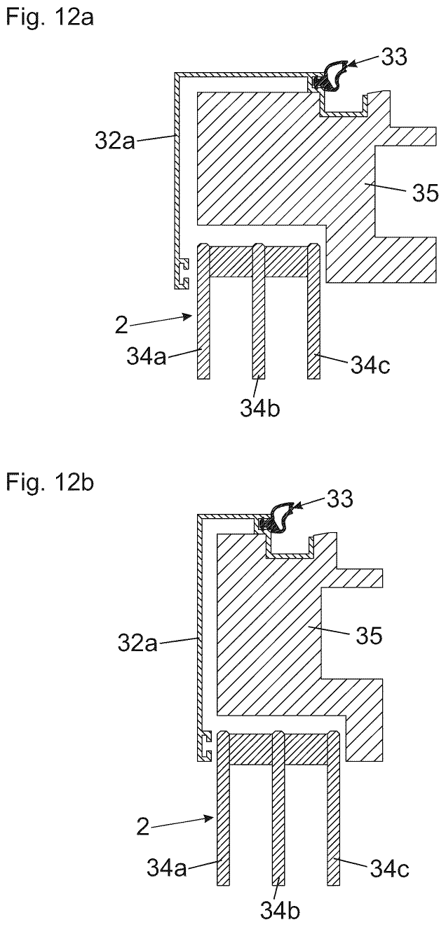

FIG. 12a and FIG. 12b shows two different embodiments of a cover element 2 with a multiple-pane insulation glass which, as already shown in FIG. 11c, includes two or more glass panels 34a, 34b, 34c at least partially spaced apart from each other. For example, the profile 32a is made of metal or plastic and is configured so as to partially receive the other profile 35, preferably made of wood or a wooden material.

FIG. 13 shows an exploded view of a part of the guide system 11 with at least one locking device 37 for releasably locking the two fitting portions 17a, 17b in the first end position and/or in the second end position.

Preferably, at least one supporting lever 13a, 13b and/or at least one drive lever 15a, 15b of the hinge lever mechanism 12 is lockable by the at least one locking device 37.

The first fitting portion 17a includes a base body 36 having at least one bearing surface 36a configured to bear against the stationary structure 1. In the shown embodiment, the base body 36 of the first fitting portion 17a is to be fixed to the stationary structure 1 via a mounting portion 52.

The locking device 37 is convenient in order to lock the fitting portions 17a, 17b in the first end position (closed position) and in the second end position, so that no relative movement of the hinge lever mechanism 12 takes place upon a lateral displacement movement of the cover element 2.

In the shown embodiment, the hinge lever mechanism 12 includes at least two drive levers 15a, 15b connected to each other via a hinge axis 16. At least one of the drive levers 15a, 15b, preferably both drive levers 15a, 15b, is or are releasably lockable by the locking device 37.

The locking device 37 includes at least one pin 40a, 40b and at least one locking contour 42a, 42b. Preferably, the locking contour 42a, 42b is configured to be open on one end. The at least one pin 40a, 40b is received within the locking contour 42a, 42b in the first end position.

Preferably, the at least one pin 40a, 40b can be introduced into the locking contour 42a, 42b upon a movement of the hinge 4a-4d from the second end position into the first end position.

In the shown embodiment, the at least one pin 40a, 40b is arranged on a locking lever 38. Preferably, the locking lever 38 is pivotally supported on the first fitting portion 17a about an axis 39.

Preferably, at least two pins 40a, 40b are provided on the locking lever 38, the pins 40a, 40b engaging into corresponding locking contours 42a, 42b of the drive levers 15a, 15b in the first end position (closed position) of the two fitting portions 17a, 17b to each other.

For controlling a movement of the locking lever 38, at least one driving roller 26b is provided. The driving roller 26b can be set into a rotational movement by the, preferably electromotive, drive device 25.

The driving roller 26b includes at least one, preferably curved, control curve 43, and a pin 41 of the locking lever 38 is guided along the control curve 43.

By a, preferably motor-assisted, rotational movement of the driving roller 26b, the pin 41 of the locking lever 38 can be guided along the control curve 43 of the driving roller 26b.

For locking the two fitting portions 17a, 17b in the first end position, the two pins 40a, 40b of the locking lever 38 are movable into the locking contours 42a, 42b of the drive levers 15a, 15b, and are movable out from the locking contours 42a, 42b for unlocking.

For locking the second end position (open position) of the fitting portions 17a, 17b, the hinge axis 16, which connects the two drive levers 15a, 15b to each other, is movable into an over-dead-center-position. In this way, the two drive levers 15a, 15b can be fixed in their relative position to each other in the second end position (that is to say in a stretched position of the drive levers 15a, 15b relative to each other) with a predetermined holding force.

In addition, the locking device 37 for locking the two fitting portions 17a, 17b in the second end position, can include at least one pin 44b and at least one abutment 48. In the second end position of the fitting portions 17a, 17b, the at least one pin 44b bears against the at least one abutment 48.

Preferably, at least one guide contour 47 is provided for displaceably supporting the at least one pin 44b, and the at least one abutment 48 is formed on an end of the guide contour 47.

Preferably, the at least one guide contour 47 is arranged on the first fitting portion 17a, preferably on the base body 36 of the first fitting portion 17a.

The control curve 43 of the drive roller 26b and the guide contour 47 of the first fitting portion 17a can be configured substantially mirror-symmetrical to each other.

The at least one pin 44b for locking the second end position of the two fitting portions 17a, 17b to each other can be arranged on a slider 44.

Preferably, the at least one slider 44 is movably supported on the drive roller 26b. In the shown embodiment, the slider 44 includes at least one pin 44a which is movably arranged within an elongated hole 46 of the drive roller 26b.

The drive roller 26b can include a, preferably linear, guide 45 for movably supporting the slider 44. Due to the guide 45, the slider 44 is at least partially radially movable in a direction of the rotational axis of the drive roller 26b.

By the, preferably electromotive, drive device 25, the fitting portions 17a, 17b of the hinge 4a-4d are movable into the first end position and/or into the second end position.

Moreover, the two fitting portions 17a, 17b, in the first end position and/or in the second end position, are releasably lockable and/or releasably unlockable by a movement, in particular a rotational movement, of the drive device 25.

The first pin 44a of the slider 44 is received within an elongated hole 46 of the driving roller 26b, and the slider 44 is movable along the guide 45 of the driving roller 26b.

The second pin 44b of the slider 44 is guided along a control curve 50 of a control portion 49 and along the guide contour 47 of the first fitting portion 17a.

The control portion 49 with the control curve 50 is firmly connected to the drive lever 15a, and no relative movement between the drive lever 15a and the control portion 49 takes place. The drive lever 15a and the control portion 49 with the control curve 50 thus jointly form a common constructional unit.

The two pins 44a, 44b of the slider 44 extend coaxially to each other and/or can be formed together, jointly with the slider 44, so as to have an integral one-piece configuration.

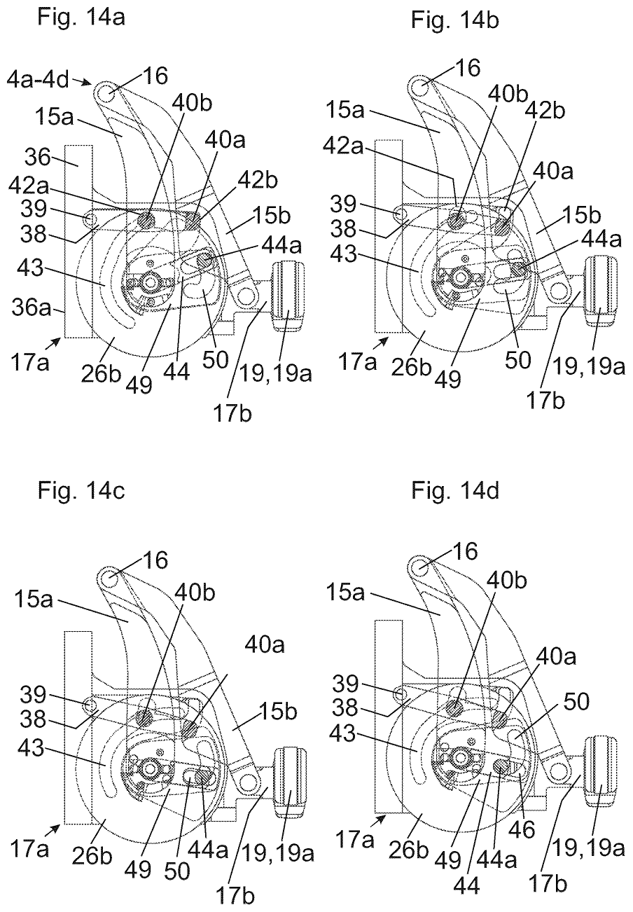

FIG. 14a-14d show the unlocking operation of the first end position of the two fitting portions 17a, 17b of the hinge 4a-4d in temporally subsequent steps.

FIG. 14a shows the first end position of the fitting portions 17a, 17b relative to each other, the first end position corresponding to a closed position of the cover element 2 relative to the stationary structure 1. It can be recognized that the two pins 40a, 40b of the locking lever 38 engage into the locking contours 42a, 42b of the drive levers 15a, 15b. Therefore, the two drive levers 15a, 15b are releasably locked by the locking device 37 in the first end position of the fitting portions 17a, 17b.

FIG. 14b shows that the drive roller 26b has been rotated by the, preferably electromotive, drive device 25 in a clockwise direction. The pin 40b of the locking lever 38 is guided in the control curve 43 of the drive roller 26b. The locking lever 38 is pivoted about the axis 39 of the first fitting portion 17a and the two pins 40a, 40b of the locking lever 38 are moved out from the two locking contours 42a,42b of the drive levers 15a, 15b.

FIG. 14c shows a continued rotational movement of the drive roller 26b in the clockwise direction, in which the pin 40b of the locking lever 38 is guided along the, preferably curved-shaped, control curve 43 so as to pivot the locking lever 38 further about the axis 39 of the first fitting portion 17a.

FIG. 14d shows that the two pins 40a, 40b of the locking lever 38, due to a continued rotational movement of the drive roller 26b, have now been pivoted entirely out from the locking contours 42a,42b of the drive levers 15a, 15b.

It is to be noted that the two drive levers 15a, 15b have not yet been moved about the hinge axis 16 between the positions shown in FIG. 14a and FIG. 14d. Accordingly, the drive levers 15a, 15b remain in their relative position to each other between the first end position of the fitting portions 17a, 17b and a rotational angle of the drive roller 26b of approximately 30°.

However, the position according to FIG. 14d marks the start of a pivoting movement of the two drive levers 15a, 15b relative to each other. The slider 44 can be guided along the guide 45 of the drive roller 26b in a radial direction towards the rotational axis of the drive roller 26b.

The first pin 44a of the slider 44 is movably supported in the elongated hole 46 of the drive roller 26b. The second pin 44b of the slider 44 engages into the curved control curve 50 of the control portion 49 and into the guide contour 47 (FIG. 13) of the first fitting portion 17a.

The control curve 50 of the control portion 49 can include at least two sections extending at an angle relative to each other, for example with an angle of approximately 90°.

By to a rotational movement of the drive roller 26b and by the co-operation of the second pin 44b with the control curve 50 and with the guide contour 47, the first pin 44a of the slider 44 is moved to the other end of the elongated hole 46. In this way, a torque-transmitting connection between the drive roller 26b and the slider 44 can be established.

Accordingly, when the drive roller 26b is driven clockwise by the, preferably electromotive, drive device 25, the first drive lever 15a, from the position according to FIG. 14d, can be entrained via the slider 44 and via the control portion 49 firmly connected to the first drive lever 15a.

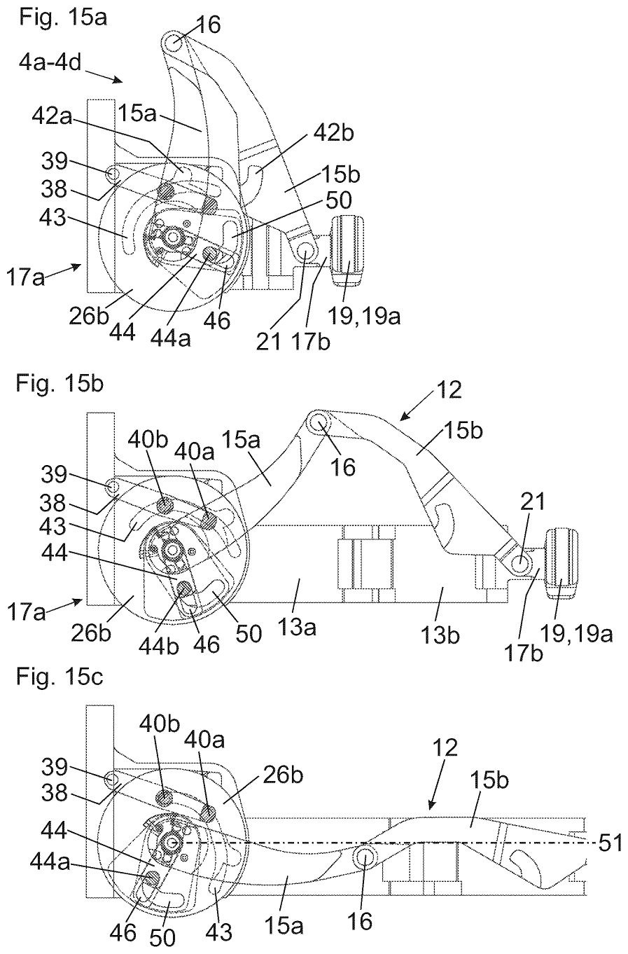

FIG. 15a-15c show the driving operation of the fitting portions 17a, 17b in a direction towards the second end position in temporally subsequent steps.

The two locking contours 42a, 42b of the two drive levers 15a, 15b can be well recognized here, the locking contours 42a, 42b being provided for locking the first end position (closed position) of the fitting portions 17a, 17b relative to each other.

Starting from the beginning of the driving movement according to the previous FIG. 14d, the first drive lever 15a can be driven via the slider 44. A, preferably motor-assisted, rotational movement of the drive roller 26b is transmitted to the control portion 49 via the two pins 44a, 44b of the slider 44, and the control portion 49 is connected to the first drive lever 15a in a rotationally fixed manner.

FIG. 15b shows a continued driving movement of the two fitting portions 17a, 17b in a direction of the second end position. A rotational movement of the drive roller 26b can be transmitted to the first drive lever 15a via the slider 44. The two supporting levers 13a, 13b can be recognized, the supporting levers 13a, 13b being connected to each other via the vertically extending hinge axis 14 (FIG. 7c) in a mounted position.

FIG. 15c shows the two fitting portions 17a, 17b in the second end position.

For locking the second end position, the hinge axis 16, which connects the two drive levers 15a, 15b to each other, is movable into an over-dead-center-position.

In other words, the hinge axis 16, in the second end position of the fitting portions 17a, 17b, is located below a notional connecting line 51 which connects the rotational axis of the drive roller 26b and the hinge axis 21 (FIG. 15b) on the second fitting portion 17b to each other.

Due to the hinge axis 16 arranged in the over-dead-center-position, the hinge lever mechanism 12 of the hinge 4a-4d can be stably held in the second end position.

In the over-dead-center-position, the first hinge lever 15a always tends to move clockwise when a force is applied to the second fitting portion 17b. However, this movement is prevented, because the two pins 40a, 40b of the locking lever 38 are located at a stop at one end of the control curve 43 of the drive roller 26b. Moreover, also the second pin 44b of the slider 44 bears against the stop 48 (FIG. 13) of the guide contour 47 of the first fitting portion 17a.

A release of the locking of the second end position of the fitting portions 17a, 17b can be made possible by a, preferably motor-assisted, counterclockwise rotational movement of the drive roller 26b.

Preferably, the two fitting portions 17a, 17b, in the first end position and/or in the second end position, are configured to be releasably locked and/or releasably unlocked by a movement, in particular a rotational movement, of the drive device 25.

A particular advantage lies in the fact that the, preferably electromotive, drive device 25 can be permanently coupled to the drive roller 26b. Therefore, it is not necessary to couple and decouple the drive device 25 via additional coupling devices.

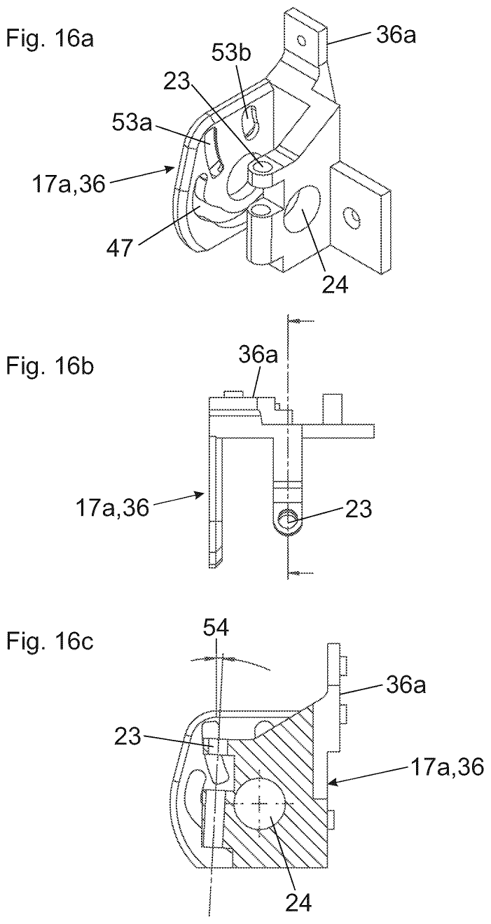

FIG. 16a-16c show the arrangement of an inclinedly extending hinge axis 23 on the first fitting portion 17a in different views.

FIG. 16a shows the base body 36 of the first fitting portion 17a, the base body 36 being configured to bear either directly via at least one bearing surface 36a or via a mounting portion 52 (FIG. 13) against the stationary structure 1.

The base body 36 of the first fitting portion 17a includes the guide contour 47 for movably guiding the slider 44 and/or at least two recesses 53a, 53b for guiding the two pins 40a, 40b of the locking lever 38 and/or at least one recess 24 for pivotally receiving a synchronization shaft 10a.

FIG. 16b shows the base body 36 of the first fitting portion 17a in a view from above.

FIG. 16c shows a cross-sectional view in a direction of the arrows depicted in FIG. 16b. It can be recognized that the hinge axis 23 extends inclinedly relative to the at least one bearing surface 36a of the first fitting portion 17a.

The hinge axis 23 slightly inclined to a vertical 54 has the purpose to slightly elevate the two supporting levers 13a, 13b, which are connected via at least one vertically extending axis 14 in the mounted position, upon a movement from the first end position of the fitting portions 17a, 17b in a direction of the second end position.

Upon a movement of the cover element 2 from the closed, first end position flush with the facade, the cover element 2 has the tendency to sag due to the force of gravity.

In order to at least partially compensate for this effect, at least one hinge axis 23 of the supporting levers 13a, 13b is slightly inclined relative to the vertical 54. As a result, the cover element 2 is elevated upon a movement from the first end position into the second end position.

The at least one hinge axis 23 encloses an angle with the vertical 54, the angle being larger than 0° and smaller than 10°. Preferably, the angle is larger than 0° and smaller than 5°, particularly larger than 0° and smaller than 2°.

In a mounted condition of the hinge 4a-4d, an upper end of the at least one hinge axis 23 is arranged closer to the at least one bearing surface 36a of the first fitting portion 17a than a lower end of the at least one hinge axis 23.

Thereby, it can be provided that the at least one hinge axis 23 is arranged on the first fitting portion 17a.

The hinge lever mechanism 12 can include at least two supporting levers 13a, 13b hingedly connected to each other via a first hinge axis 14. Each of the supporting levers 13a, 13b has a longitudinal axis which, at least in the second end position of the fitting portions 17a, 17b, extends inclinedly to a perpendicular to the at least one bearing surface 36 of the at least one first fitting portion 17a.

According to an embodiment, the angle between the longitudinal direction of the supporting levers 13a, 13b and the perpendicular can be reduced in a condition loaded by the at least one cover element 2.

In other words, the supporting levers 13a, 13b are slightly elevated upon a movement from the first end position into the second end position due to the arrangement of the inclinedly extending hinge axis 23. This elevating movement of the supporting levers 13a, 13b can be again compensated by a weight of the cover element 2. As a result, upon a movement from the closed position into the open position in which the cover element 2 is spaced apart from the stationary structure 1 in a parallel relationship, the cover element adopts substantially a constant height position.

Preferably, the hinge lever mechanism 12 includes at least one, preferably more than one, further hinge axis 22, 16, 21 (FIG. 7c) extending parallel to the at least one bearing surface 36a of the at least one first fitting portion 17a.

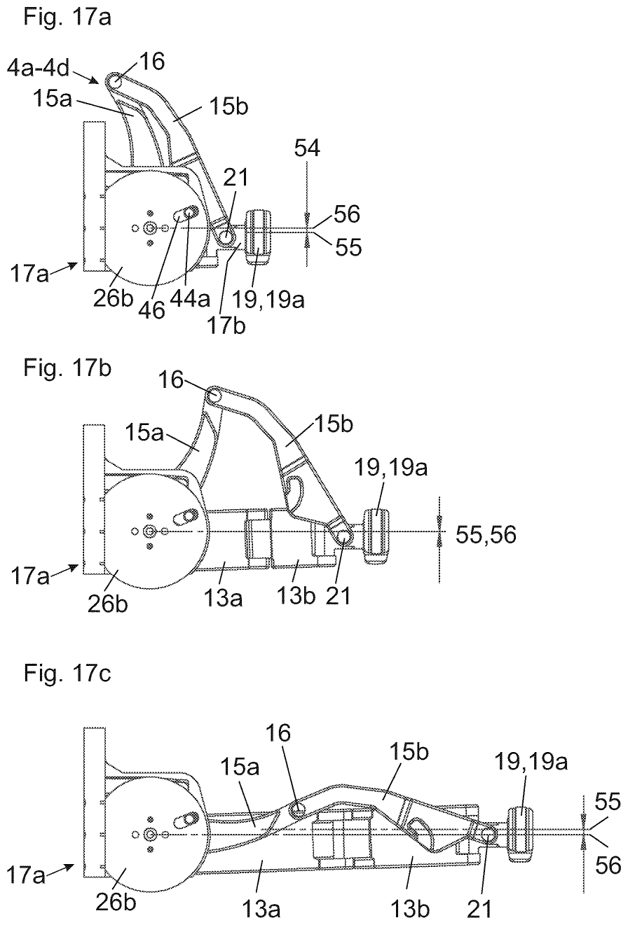

FIG. 17a-17c shows a movement of the fitting portions 17a, 17b from the first end position in a direction of the second end position, in which the hinge axis 23 (not shown here) according to the previous FIGS. 16a-16c is slightly inclined relative to a vertical 54.

FIG. 17a shows the first end position of the fitting portions 17a, 17b relative to each other. It can be recognized that the rotational axis 55 of the running wheel 19a of the running carriage 19 is located slightly below the rotational axis 56 of the drive roller 26b.

FIG. 17b shows an intermediate position located between the first end position and the second end position of the fitting portions 17a, 17b relative to each other. It can be recognized that the supporting levers 13a, 13b have been elevated due to the inclinedly extending hinge axis 23, so that the rotational axis 55 of the running wheel 19a and the rotational axis 56 of the drive roller 26b are now located at an identical height.

FIG. 17c shows a further position of the fitting portions 17a, 17b relative to each other. It can be recognized that the supporting levers 13a, 13b have further been elevated due to the inclinedly extending hinge axis 23, so that the rotational axis 55 of the running wheel 19a is now arranged above the rotational axis 56 of the drive roller 26b. The elevating movement of the supporting levers 13a, 13b can be again compensated by the weight of the cover element 2, so that the cover element 2 can always be guided at a constant height when moving between the two end positions.

1. A guide system for movably supporting at least one cover element for covering an opening in a stationary structure, the at least one cover element being movable by the guide system between a closed position, in which the at least one cover element covers the opening, and an open position, in which the at least one cover element is spaced apart from the opening substantially orthogonally, the guide system comprising:
at least one, preferably more than one, hinge, the at least one hinge including at least a first fitting portion configured to be arranged on the stationary structure, at least a second fitting portion configured to be arranged on the at least one cover element, and at least one hinge lever mechanism configured to move the two fitting portions substantially linearly between a first end position, which corresponds to a closed position of the cover element, and a second end position, which corresponds to an open position of the cover element, and
at least one locking device configured to lock the two fitting portions in the first end position and/or in the second end position.

2. The guide system according to claim 1, wherein the at least one hinge lever mechanism includes at least two drive levers connected to each other via a hinge axis, wherein at least one of the drive levers is releasably lockable by the at least one locking device.

3. The guide system according to claim 2, wherein the at least one locking device includes at least one pin and at least one locking contour, preferably open on one side, wherein the at least one pin is received within the locking contour in the first end position of the two fitting portions, preferably wherein the at least one pin is insertable into the locking contour upon a movement of the hinge from the second end position into the first end position.

4. The guide system according to claim 3, wherein the at least one pin is arranged on a locking lever, preferably wherein the locking lever is pivotally supported on the first fitting portion about an axis.

5. The guide system according to claim 4, wherein at least one control curve for controlling a movement of the locking lever is provided, preferably wherein the at least one control curve is arranged on a drive wheel configured to be driven by a, preferably electromotive, drive device.

6. The guide system according to claim 3, wherein the at least one locking contour is arranged on at least one of the drive levers.

7. The guide system according to claim 2, wherein the hinge axis of the drive levers for releasably locking the second end position is movable into an over-dead-center-position.

8. The guide system according to claim 2, wherein the at least one locking device includes at least one pin and at least one abutment, the at least one pin bearing against the at least one abutment in the second end position, preferably wherein at least one guide contour for displaceably supporting the at least one pin is provided and the at least one abutment is arranged on an end of the guide contour.

9. The guide system according to claim 8, wherein the at least one pin is arranged on at least one slider, preferably wherein the slider is displaceably supported on a drive wheel configured to be driven by a, preferably electromotive, drive device, wherein it is particularly preferred that at least one guide is provided for displaceably supporting the at least one slider.

10. The guide system according to claim 8, wherein the at least one guide contour is arranged on the first fitting portion.

11. The guide system according to claim 1, further comprising at least one, preferably electromotive, drive device for moving the at least one hinge into the first end position and/or into the second end position.

12. The guide system according to claim 11, wherein the two fitting portions, in the first end position and/or in the second end position, are configured to be releasably locked and/or releasably unlocked by a movement, in particular a rotational movement, of the drive device.

13. An arrangement comprising:
a stationary structure, at least one opening arranged therein,
at least one cover element, and
the guide system according to claim 1,
wherein the cover element is movable by the guide system between a closed position, in which the cover element covers the opening, and an open position, in which the cover element is spaced apart from the opening substantially orthogonally, and a displacement position, in which the cover element is arranged laterally offset with respect to the opening.

14. The arrangement according to claim 13, wherein the cover element is configured substantially quadrangular, and wherein the guide system includes four hinges which, in the closed position, are arranged in a region of the four corners of the cover element, preferably wherein two hinges are arranged vertically spaced apart from each other on the stationary structure, and two hinges are arranged vertically spaced apart from each other on the cover element and being connected to the cover element in a movement-coupled manner.

15. The arrangement according to claim 13, wherein the cover element is a window, a blind and/or a door, and is arranged flush with the stationary structure or slightly projecting from the opening of the stationary structure in a closed condition.
